(19) United States
(12) Patent Application Publication
(10) Pub. No.: US 2004/0004662 A1
(43) Pub. Date: Jan. 8, 2004

(54) Programmable high-speed tracing and locating camera apparatus

(76) Inventor: Chi-Sheng Hsieh, Yuan-Shan Shiang (TW)

Correspondence Address: Dennison, Schultz & Dougherty, 612 Crystal Square 4, 1745 Jefferson Davis Highway, Arlington, VA, 22202-3417, US

(21) Appl. No.: 10/610,630

(22) Filed: Jul. 2, 2003

Related U.S. Application Data
(63) Continuation-in-part of application No. 09/553,359, filed on Apr. 21, 2000.

(51) Int. Cl. H04N 5/225

(52) U.S. Cl. 348/169

(57) ABSTRACT

This invention provides a high-speed tracking and locating camera apparatus and, more specifically, it is a programmable high-speed tracking and locating camera apparatus, the scanning mode of this camera apparatus can be preset by a control program with a computer interface to anticipated scanning pattern, the control and management procedure of this camera apparatus is very simple to proceed. This invention can send the tracking and locating signal direct to its camera apparatus; it can also pre-schedule the scanning pattern for the tracking camera apparatus, besides, the camera apparatus is designed to have multi-point interrupt function, the camera apparatus can be used as a fixed area scanning camera apparatus in general condition, but once a sensor detect any special event, this camera apparatus can lock the related location and keep on tracking that place, hence achieve the seamless monitoring job. On the other hand, this invention can also be used as a cooperative apparatus for a networking videoconference, provides multi-functional network service with both monitoring and tracking.

### CROSS REFERENCE OF RELATED APPLICATION

The present invention is a Continuation-in-part (CIP) application of a pending non-provisional patent application with application Ser. No. 09/553,359 filed on Apr. 21, 2000.

### BACKGROUND OF THE INVENTION

1. Field of the Invention

This invention relates to a high-speed tracking and locating camera apparatus and, more specifically, a programmable high-speed tracking and locating camera apparatus. The camera apparatus uses a single-chip micro-processor to generate a control analog pulse signal. The control analog pulse signal is compared with a reference pulse signal generated from a DC motor upon rotation, thereby producing a result pulse signal. The result pulse signal is amplified by a driving amplifier circuit so as to drive the DC motor to rotate or stop running. On one hand the rotating shaft of the DC motor is engaged with a potentiometer in order to generate corresponding reference pulse signals, on the other hand it carry a camera apparatus and provides tracking and locating functions of the camera apparatus.

2. Description of the Prior Art

As in conventional applications, the tracking camera apparatus uses a camera, which is fixed onto a motor-driven rotator, scanning back and forth with a fixed speed to expand its monitoring scope. The motor-driven motor fixing the camera can be divided into three types. The first type is a step motor, which has advantages of lower torque and slow rotational speed. The second type is a servo motor, which is costly to manufacture, complicated in structure and inconvenient in maintenance. However, the locating mechanism of the servo motor is relative precious and can be used for some special purpose. The third type is a DC motor, which is cost-effective. The DC motor has a higher torque and a higher rotational speed than the step motor and a lower cost than the servo motor. Although the scanning range of the camera lens is from 45 degree to 120 degree, this DC motor is suitable for popular use.

Please refer to U.S. Pat. No. 5,802,412 entitled “MINITURE PAN/TILT TRACKING MOUNT”, wherein the monitoring scanning operation is performed by using a microprocessor to generate a digital signal to a limit sensor, and the limit sensor sends back a signal to the microprocessor. After the microprocessor receives the signal from the limit sensor, the software and the circuit system of the microprocessor is used to change the location of the motor. Since such method uses the microprocessor for determination, the cost and the activating time thereof are higher than those of the present apparatus.

Accordingly, the above-described prior art product is not a perfect design and has still many disadvantages to be solved

In views of the above-described disadvantages resulted from the conventional camera apparatus, the applicant keeps on carving unflaggingly to develop an improved corona generator structure according to the present invention through wholehearted experience and research.

### SUMMARY OF THE INVENTION

The purpose of this invention is to provide a programmable high-speed tracking and locating camera apparatus, this camera apparatus can scan both horizontally and vertically with a high speed when the monitoring scanning operation is performed, it can preset the high-speed tracking and locating functions so the overall monitoring system does not have any blind spot.

Another sub-objective of this invention is to provide a programmable high-speed tracking and locating camera apparatus, by applying some simple structured devices; the camera apparatus can have same functions as the speed dome camera, the price of this invention is lower, the size of this invention is smaller, as a whole, this invention is very easy to produce, operate and maintain.

Another sub-objective of this invention is to provide a programmable high-speed tracking and locating camera apparatus, this invention can be applied in general monitoring, tracking and locating system, and in a networking videoconference system, thus have convenient multiple functions.

Yet another sub-objective of this invention is to provide a programmable high-speed tracking and locating camera apparatus, so the users can easily setup and manage the related monitoring system without performing any complicated operating procedure.

The purpose of this invention is to provide a programmable high-speed tracking and locating camera apparatus, when the monitoring scanning operation is performed, this camera apparatus can control the automatic rotation of the driving device with a high or low speed, the locating memories of preset points or functions of calling interrupt signals in a remote control manner according to TCP/IP telecommunication protocols, this camera apparatus can scan both horizontally and vertically with a high speed, it can preset the high-speed tracking and locating functions so the overall monitoring system does not have any blind spot.

Another sub-objective of this invention is to provide a programmable high-speed tracking and locating camera apparatus, the movement of the driven motor is performed by using a single-chip micro-processor to transmit a control analog pulse signal to a comparator, this comparator needs not feed backs a signal to the single-chip micro-processor; another DC motor drives a potentiometer to generate a reference pulse signal, such reference pulse signal is transmitted to the comparator, the comparator receives the reference pulse signal and the control analog pulse signal for comparison so as to generate a result pulse signal, the result pulse signal is used to determine operation direction of the DC motor.

With respect to above mentioned advantages, the principle of this programmable high-speed tracking and locating camera apparatus is to use a single-chip micro-processor controlling at least one driving device, and use the DC motor of this driving device to carry a camera for a horizontal scanning, meanwhile, the camera apparatus can perform multiple functions such as tracking and locating, when it work with respect to computer program, the camera apparatus can be setup for its routine management. The major components of this invention comprise at least: an input device, a memory management device, at least one driving device and a camera apparatus.

### BRIEF DESCRIPTION OF THE DRAWINGS

The drawings disclose an illustrative embodiment of the present invention which serves to exemplify the various advantages and objects hereof, and are as follows:

FIG. 1A is a schematic diagram showing operations of a driving device according to prior art;

FIG. 1B is a schematic diagram showing operations of a driving device according to the present invention;

FIG. 2 is a configuration block diagram showing the movement of the driving device according to the present invention;

FIG. 3 is a first configuration block diagram of the present invention;

FIG. 4 is a second configuration block diagram of the present invention;

FIG. 5 is a mathematical presentation of pulse interaction diagram of the present invention;

FIG. 6 is a schematic diagram showing a driving device according to the present invention; and

FIG. 7 is a circuit diagram according to an embodiment of present invention.

### DETAILED DESCRIPTION OF THE PREFERRED EMBODIMENT

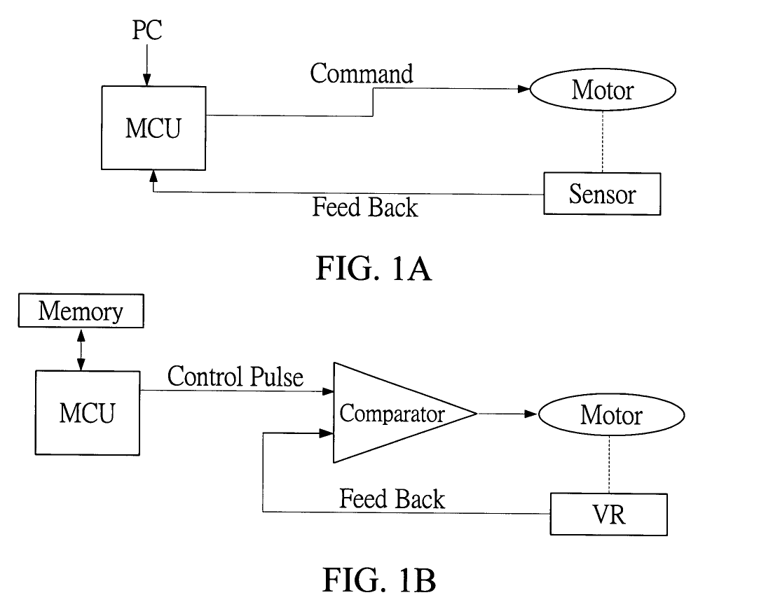

Please refer to FIG. 1 depicting U.S. Pat. No. 5,802,412 entitled “MINITURE PAN/TILT TRACKING MOUNT”, wherein the monitoring scanning operation is performed by using a microprocessor to generate a digital signal to a limit sensor, and the limit sensor sends back a signal to the microprocessor. After the microprocessor receives the signal from the limit sensor, the software and the circuit system of the microprocessor is used to change the location of the motor. Since such method uses the microprocessor for determination, the cost and the activating time thereof are higher than those of the present apparatus.

Please refer to FIG. 1B, which is a schematic diagram showing operations of a driving device according to the present invention. The single-chip micro-processor transmits a control analog pulse signal to the driving device. After the comparator of the driving device receives the control analog pulse signal from the single-chip micro-processor, no signal is needed to be fed back to the single-chip micro-processor. In addition, the DC motor of the driving device drives a potentiometer to generate a reference pulse signal to the comparator via an engagement gear assembly. The comparator receives the reference pulse signal and the control analog pulse signal for comparison so as to generate a result pulse signal. The result pulse signal is used to determine operation of the DC motor.

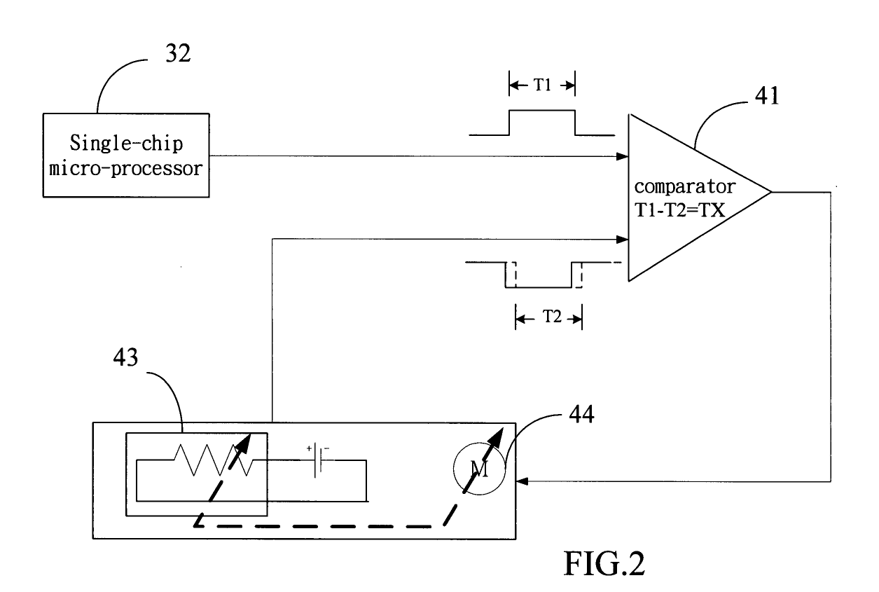

Please refer to FIG. 2, which is a configuration block diagram depicting the movement of the driving device according to the present invention. When the single-chip micro-processor 32 of a memory management device 3 receives data signals from the input device 1 or the memory 31, the single-chip micro-processor 32 transmits a control analog pulse signal T1 to the driving device 4. After the comparator 41 of the driving device 4 receives the control analog pulse signal T1 from the single-chip micro-processor 32, no signal is needed to be fed back to the single-chip micro-processor 32. In addition, the DC motor 44 of the driving device 4 drives the potentiometer 43 to generate a reference pulse signal T2 to the comparator 41. The comparator 41 receives the reference pulse signal T2 and the control analog pulse signal T1 for comparison so as to generate a result pulse signal TX. The result pulse signal TX is used to determine operation of the DC motor 44.

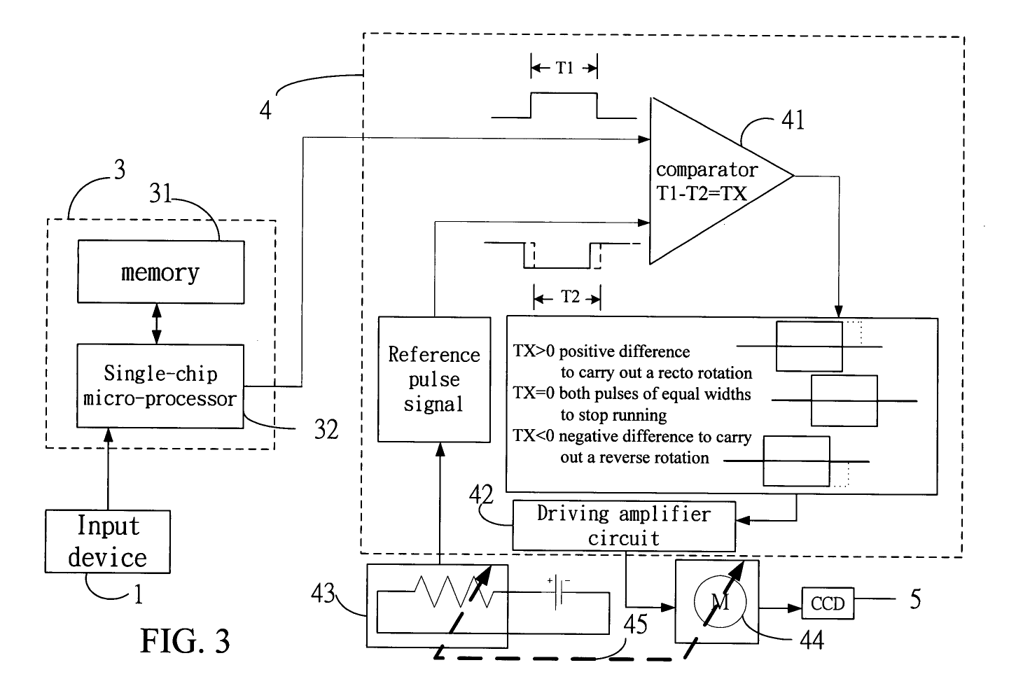

FIG. 3 depicts a diagram of main architecture of present invention, the components provided by this programmable high-speed tracking and locating camera apparatus comprises: an input device 1, a memory management device 3, a driving device 4 and a camera apparatus 5, wherein the memory management device 3 consists of a memory 31 and a single-chip micro-processor 32.

The input device 1 transmits the data signals to the memory management device 3 by means of a keyboard, a touch screen, a computer, PDA, network or speech sound or by means of RS232 [symbol] RJ45 [symbol] RS485 [symbol] IEEE1394 or via wireless transmission such as bluetooth or infrared wireless transmission modules.

The memory management device 3 consists of at least a memory 31 and a single-chip micro-processor 32. After the memory management device 3 receives the data signals from the input device 1 or the memory 31, a control analog pulse signal T1 is provided to the driving device 4.

The driving device 4 consists of a comparator 41, a driving amplifier circuit 42, a potentiometer 43, a DC motor 44 and an engagement gear assembly 45. When the driving device 4 receives a control analog pulse signal T1 from the memory management device 3 and a reference pulse signal T2, the DC motor 44 is driven to operate according to the determination of the result pulse signal TX via the comparator 41. The reference pulse signal T2 is a reference pulse signal T2 generated from the potentiometer 43 driven by the DC motor 44 through the engagement gear assembly 45.

The camera apparatus 5 is provided on the driving device 4 for capturing images within different scanning angles by using the DC motor 44 of the driving device 4. The camera apparatus 5 can be a CCD, a mirror, a TFT or an illuminating light.

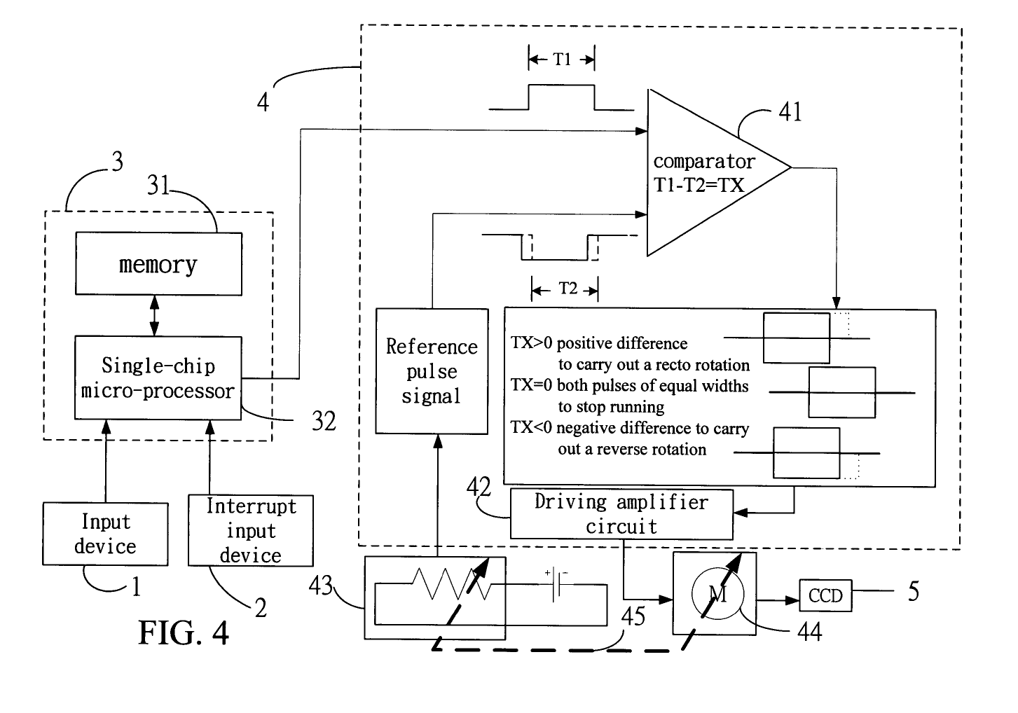

FIG. 4 depicts a diagram of main architecture of the present invention, the components provided by this programmable high-speed tracking and locating camera apparatus comprises: an input device 1, an interrupt input device 2, a memory management device 3, a driving device 4 and a camera apparatus 5, wherein the memory management device 3 consists of a memory 31 and a single-chip micro-processor 32.

The input device 1 transmits the data signals to the memory management device 3 by means of a keyboard, a touch screen, a computer, PDA, network or speech sound or by means of RS232 [symbol] RJ45 [symbol] RS485 [symbol] IEEE1394 or via wireless transmission such as bluetooth or infrared wireless transmission modules.

The interrupt input device 2 transmits the data signals to the memory management device 3 by means of a keyboard, a touch screen, a computer, PDA, network or speech sound or by means of RS232 [symbol] RJ45 [symbol] RS485 [symbol] IEEE1394 or via wireless transmission such as bluetooth or infrared wireless transmission modules, thereby simultaneously interruptting operations of the single-chip micro-processor 32 and changing the camera apparatus 5 to an assigned position.

The memory management device 3 consists of at least a memory 31 and a single-chip micro-processor 32. After the memory management device 3 receives the data signals from the input device 1 or the memory 31, a control analog pulse signal T1 is provided to the driving device 4.

The driving device 4 consists of a comparator 41, a driving amplifier circuit 42, a potentiometer 43, a DC motor 44 and an engagement gear assembly 45. When the driving device 4 receives a control analog pulse signal T1 from the memory management device 3 and a reference pulse signal T2, the DC motor 44 is driven to operate according to the determination of the result pulse signal TX via the comparator 41. The reference pulse signal T2 is a reference pulse signal T2 generated from the potentiometer 43 driven by the DC motor 44 through the engagement gear assembly 45.

The camera apparatus 5 is provided on the driving device 4 for capturing images within different scanning angles by using the DC motor 44 of the driving device 4. The camera apparatus 5 can be a CCD, a mirror, a TFT or an illuminating light.

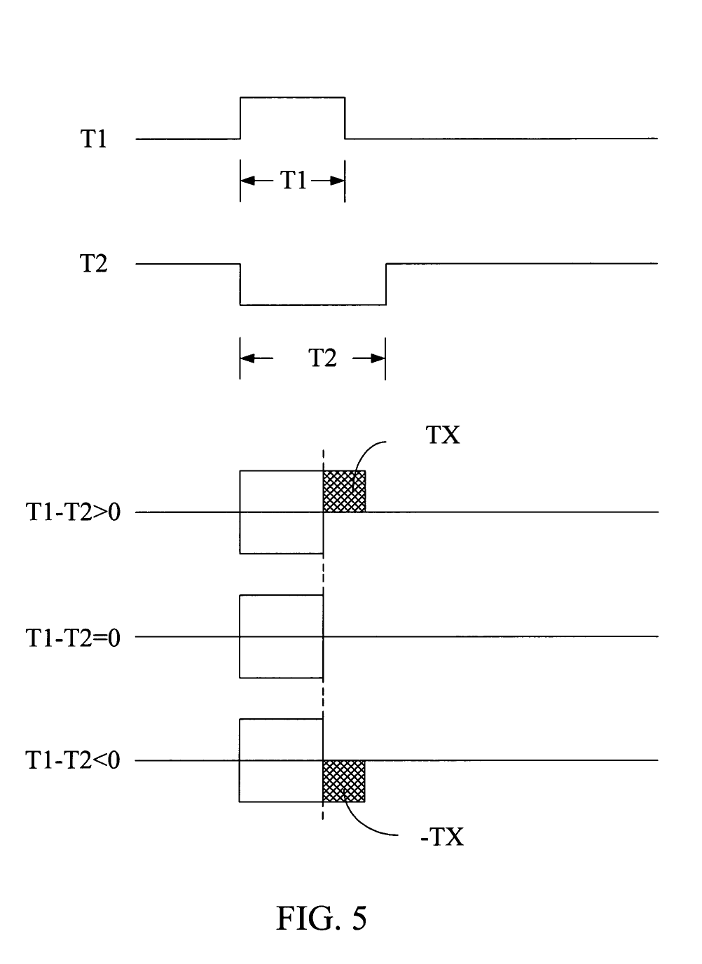

Please refer to FIG. 5. When a user inputs signals to the single-chip micro-processor 32 via the input device 1 or the interrupt signal switch is activated, the single-chip micro-processor 32 reads out the locating data stored in the memory 31, and then outputs a corresponding control analog pulse signal T1 of a constant value to the comparator 41 of the driving device 4. Different control analog pulse signals T1 have different pulse widths. The pulse width thereof equals to the product of resistance R and capacitance C (i.e. T=R*C). If the capacitance C is kept unchanged, the DC motor 44 will generate and output a reference pulse signal T2 to the comparator 41 of the driving device 4 because the potentiometer 43 is driven when the DC motor 44 is rotated. The comparator 41 of the driving device 4 receives the reference pulse signal T2 and the control analog pulse signal T1 for comparison so as to generate a result pulse signal TX. The phase of the control analog pulse signal T1 is designed to be inverse to that of the reference pulse signal T2 for a purpose of facilitating determination of the comparator 41. When the summation result of the comparator 41 generates a result pulse signal TX larger than zero (TX>0), i.e. a positive difference, the result pulse signal TX will be amplified by the driving amplifier circuit 42 of the driving device 4 and drive the motor to carry out a recto rotation. On the contrary, when the result pulse signal TX is smaller than zero (TX<0), i.e. a negative difference, the motor is driven to carry out a reverse rotation. When the result pulse signal TX is equal to zero (TX=0), the motor will stop running.

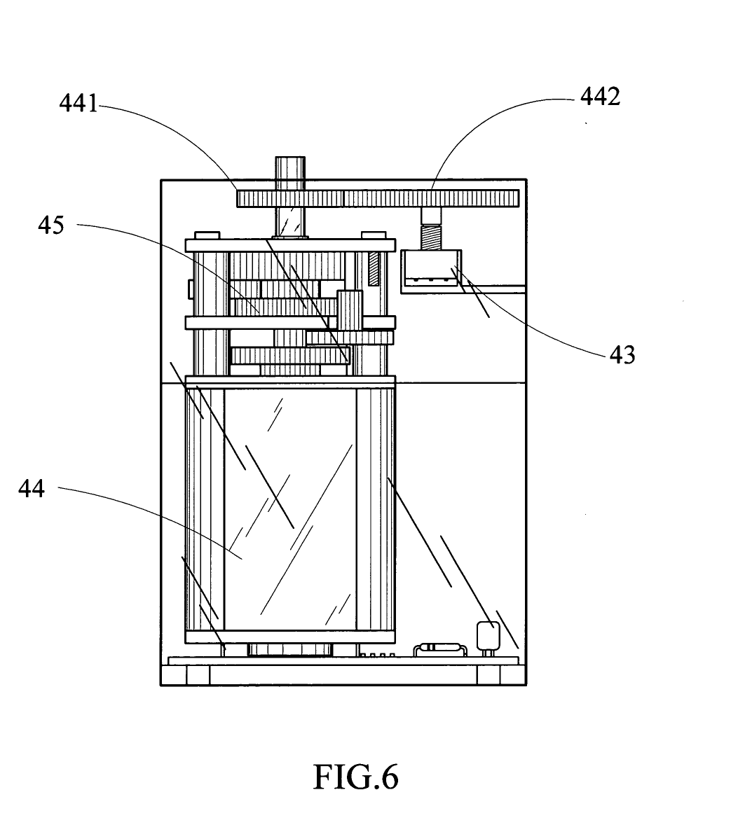

Please refer to FIG. 6, which is a schematic diagram showing a driving device 4 according to the present invention. The output shaft of the DC motor 44 is engaged with a small gear 441 of an engagement gear assembly 45 such that the motive force outputted from the DC motor 44 can drive the large gear 442 of the potentiometer 43 and the engagement gear assembly 43 of the potentiometer 43 will be engaged with the small gear of the DC motor 44. The tooth ratio of the small gear 441 of the DC motor 44 to the engagement gear assembly 43 of the potentiometer 43 is approximately 2:1 such that when the small gear 441 rotates for one turn, the large gear 442 of the potentiometer 43 rotates for only half a turn. Therefore, the DC motor 44 can rotates about 360 degree without being restricted by the rotatable acute angle of the mechanical structure of the potentiometer 43.

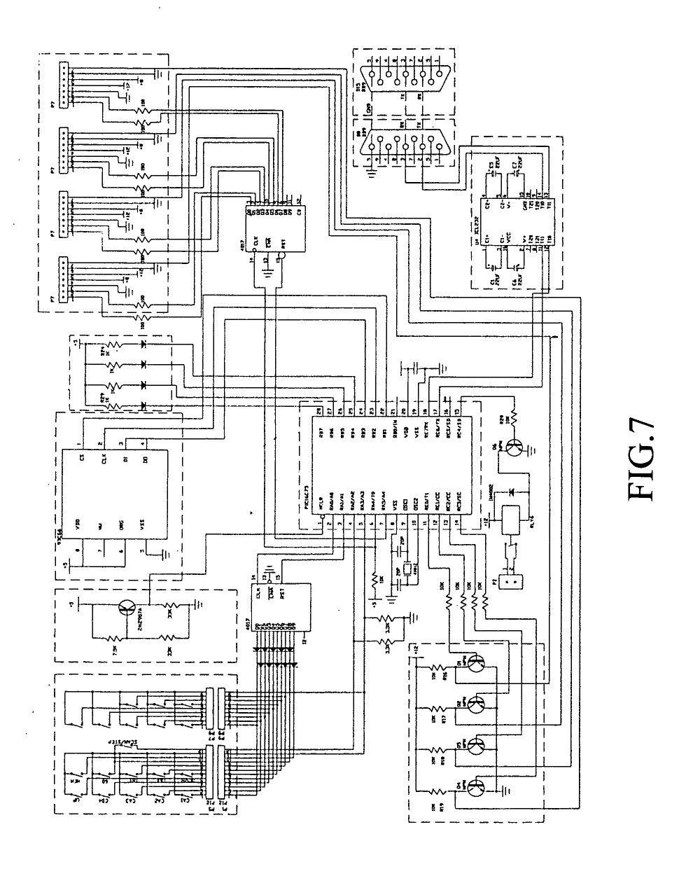

FIG. 7 depicts a circuit diagram according to an embodiment of the present invention, such circuit comprises an input device 1, an interrupt input device 2, a memory management device 3, a driving device 4 and a camera apparatus 5, wherein the memory management device 3 consists of a memory 31 and a single-chip micro-processor 32. The input device 1 or the interrupt input device 2 transmits the data signals to the memory management device 3 by means of a keyboard, a touch screen, a computer, PDA, network or speech sound or by means of RS232 [symbol] RJ45 [symbol] RS485 [symbol] IEEE1394 or via wireless transmission such as bluetooth or infrared wireless transmission modules.

The transmits the data signals to the memory management device 3 by means of a keyboard, a touch screen, a computer, PDA, network or speech sound or by means of RS232 [symbol] RJ45 [symbol] RS485 [symbol] IEEE1394 or via wireless transmission such as bluetooth or infrared wireless transmission modules, thereby controlling interrupt operations of the memory management device 3 or providing a control analog pulse signal T1 to the driving device 4 after a data signal is provided into the single-chip micro-processor 32. The memory management device 3 consists of at least a memory 31 and a single-chip micro-processor 32. and changing the camera apparatus 5 to an assigned position. When the driving device 4 receives a control analog pulse signal T1 from the memory management device 3 and a reference pulse signal T2, the DC motor 44 is driven to operate according to the determination of the result pulse signal TX via the comparator 41. The reference pulse signal T2 is a reference pulse signal T2 generated from the potentiometer 43 driven by the DC motor 44 through the engagement gear assembly 45. The driving device 4 consists of at least a comparator 41, a driving amplifier circuit 42, a potentiometer 43, a DC motor 44 and an engagement gear assembly 45. When the driving device 4 receives the control analog pulse signal T1 from the memory management device 3 and the reference pulse signal T2, the DC motor 44 is driven to operate according to the determination of the result pulse signal TX via the comparator 41. The DC motor 44 drives the potentiometer 43 to generate a reference pulse signal T2 to the comparator 41 via an engagement gear assembly 45. The camera apparatus 5 is provided on the driving device 4 for capturing images within different scanning angles by using the DC motor 44 of the driving device 4. The camera apparatus 5 can be a CCD, a mirror, a TFT or an illuminating light.

The present invention can control the automatic rotation of the driving device 4 with a high or low speed, the locating memories of preset points or functions of calling interrupt signals in a remote control manner according to TCP/IP telecommunication protocols. Furthermore, by means of the control of the input device 1, the present invention can operate at least one driving device 4 so as to provide a clearer and wider scanning angle for the camera apparatus 5.

The programmable high-speed tracking and locating camera apparatus of present invention, when comparing with other previous conventional technologies, have following advantages:

1. Simple architecture with smaller size, taking fewer space and thus is easy to produce and operate.

2. Functions of faster scanning speed, wider tracking and locating angle, fully exploiting the capability of the monitoring system, so there is no dead corner in either temporal or spatial point of view.

3. The present invention can be applied in a networking environment, it is very useful for the videoconference application or for image file transmitting over the computer network.

4. The multi-functional operating mode of present invention is more advance than those previous technologies.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

[Represent Symbols of Major Parts]

1 input device

2 interrupt input device

3 memory management device

31 memory

32 single-chip micro-processor

T1 positive analog pulse signal

T2 reference pulse signal

TX result pulse signal

T pulse width

4 driving device

41 comparator

42 driving amplifier circuit

43 potentiometer

44 DC motor

441 small gear

442 large gear

45 engagement gear assembly

5 camera apparatus

In the claims:

1. (Original) A programmable high-speed tracking and locating camera apparatus, at least consisting of:
an input device for inputting data to a memory management device;
a memory management device comprising at least a memory and a single-chip micro-processor, providing a control analog pulse signal to a driving device after the data from the input device is received;
a driving device comprising at least a comparator, a driving amplifier circuit, a potentiometer, a DC motor and an engagement gear assembly, when said driving device receives said control analog pulse signal from said memory management device and a reference pulse signal, a result pulse signal is determined by said comparator, said result pulse signal is amplified by said driving amplifier circuit so as to drive operation or rotational directions of said DC motor, wherein said reference pulse signal is a reference pulse signal generated from said potentiometer driven by said DC motor through said engagement gear assembly; and
a camera apparatus for capturing images within different scanning angles by using said DC motor of said driving device.

2. (Original) A programmable high-speed tracking and locating camera apparatus, at least consisting of:
an input device for inputting data to a memory management device;
an interrupt for inputting data to a memory management device, thereby interrupting operation of a single-chip micro-processor;
a memory management device comprising at least a memory and a single-chip micro-processor, providing a control analog pulse signal to a driving device after the data from the input device is received;
a driving device comprising at least a comparator, a driving amplifier circuit, a potentiometer, a DC motor and an engagement gear assembly, when said driving device receives said control analog pulse signal from said memory management device and a reference pulse signal, a result pulse signal is determined by said comparator, said result pulse signal is amplified by said driving amplifier circuit so as to drive operation or rotational directions of said DC motor, wherein said reference pulse signal is a reference pulse signal generated from said potentiometer driven by said DC motor through said engagement gear assembly; and
a camera apparatus for capturing images within different scanning angles by using said DC motor of said driving device.

3. (Currently Amended) The programmable high-speed tracking and locating camera apparatus according to claim 1 or 2, wherein said input device transmits said data to said memory management device via RS232 [symbol] RJ45 [symbol] RS485 [symbol] IEEE1394, bluetooth or infrared wireless transmission modules.

4. (Currently Amended) The programmable high-speed tracking and locating camera apparatus according to claim 1 or 2, wherein said camera apparatus is a CCD, an illuminating light, a mirror or a TFT.

5. (Currently Amended) The programmable high-speed tracking and locating camera apparatus according to claim 1 or 2, wherein said engagement gear assembly of said driving device is not influenced by the mechanical structure of said potentiometer, said engagement gear assembly is a gear assembly driven with engagement of said DC motor and said potentiometer such that said DC motor can rotate about 360 degree within effective rotational range of said potentiometer.

6. (Currently Amended) The programmable high-speed tracking and locating camera apparatus according to claim 1 or 2 being provided with one or at least one driving device.

7. (Currently Amended) The programmable high-speed tracking and locating camera apparatus according to claim 1 or 2, wherein the automatic rotation of said driving device with a high or low speed, the locating memories of preset points or functions of calling interrupt signals are controlled in a remote control manner according to TCP/IP telecommunication protocols.
